(19) United States
(12) Patent Application Publication
(10) Pub. No.: US 2024/0316377 A9
(43) Pub. Date: Sep. 26, 2024

(54) PROJECTILE FIRE EXTINGUISHING INVENTION

(71) Applicant: Thomas E. S Haskins, Holbrook, MA (US)

(72) Inventor: Thomas E. S Haskins, Holbrook, MA (US)

(21) Appl. No.: 17/690,284

(22) Filed: Mar. 9, 2022

Related U.S. Application Data
(60) Provisional application No. 63/149,242, filed on Feb. 13, 2021.

(51) Int. Cl. A62C 19/00; A62C 27/00

(52) U.S. Cl. CPC A62C 19/00; A62C 3/025; A62C 27/00; F42B 12/50; A62C 99/0027

(57) ABSTRACT

When it comes to extinguishing destructive fires, one of the greatest tragedies of property loss in fires is the damage done by the water during the extinguishing process. It can be extreme. This invention eliminates the water and the resulting damage and greatly reduces the cost of cleanup and repair after the fire is extinguished.

Furthermore, the greatest threat to fire emergency personnel is close proximity to the fire. Often times, in order to put out a fire, such as in a building, a firefighter must enter the building to get access to the fire. This entails great danger and sometimes death or injury. This invention makes it easier and faster for firefighters to apply fire-extinguishing agents to the fire without entering the building.

Current technology does not offer these benefits.

### PURPOSE

To provide a method for extinguishing fires of various kinds from a distance without using water and with substantially less danger to emergency personnel and damage to property.

### INITIAL COMMENT

Introduction of this product to the industry is expected to fully disrupt the current market world-wide and use of this product in emergency fire conditions or fire control conditions will transform the power of operators to save lives and property.

### This Product is Three-Fold

Part one provides for a portable glass, plastic or other material ball filled with a dry fire extinguishing powder that can be thrown or shot at low or high speeds at a fire where it will shatter or burst, spreading the extinguishing powder all over the fire and all local surfaces to smother the fire. This allows users to extinguish fires from a distance and without using water which causes terrible damage to property and requires massive cleanup after fire is extinguished.

Part two provides for a portable, one man operated delivery system for delivering these fire extinguishing projectiles to the fire from a distance by firing them out of a barrel, at high or low speeds, which draws from a holding tank containing many of such fire extinguishing projectiles of fire extinguishing powder. This is akin to a high-powered tennis ball or baseball pitching machine and can be turned in any direction and the barrel can be pointed high or low to any height.

Part three provides a larger and more powerful delivery system, with much larger reserve tanks, with a much larger reservoir tank, all mounted on a small, medium or large truck or other vehicle so that it can be delivered to the location of the fire. One version of this vehicle could include an extension ladder and cannon barrel like a typical large water-delivering fire truck but this extension ladder, would includes a delivery cannon barrel instead of a water hose/cannon that could be raised and extended up to and even into the fire. This cannon would fire the fire extinguishing projectiles at speeds and rapidity set by the operator from low to very high speed and rate, directly into the fire. It could be swiveled and pointed in any direction and to any height both at the base and at the top or end of the cannon.

This design provides for almost no danger to emergency personnel, prevents water damage to property and requires only shovels and vacuums to clean up after fire is extinguished. Furthermore, while in cold weather water freezes and in very hot fires it evaporated immediately, these dry fire extinguishing powders would do neither.

Since I do not have a prototype yet on this part I cannot provide a video showing installation. The best option is for us to have a video conference in which I describe the process online using the drawings and pointers. For more information please contact Tom Haskins at 508-922-1909 or tom@geninvent.com

### BACKGROUND OF THE INVENTION

### 1. Field of the Invention

The present invention generally relates to fire extinguishing, in this case using a projectile filled with a fire extinguishing powder (likely dry), which projectile could come in many forms but the mostly likely best form would be that of a ball. The walls of the projectile could be made of a variety of materials but would most likely be made of fire-retardant plastic or a form of glass that turns to powder or non-dangerous debris when it shatters. This device would be used in any conditions or situations where fires need to be controlled or quickly extinguished from a distance or nearby.

### 2. Description of Related Art

Current products available on the market for fire extinguishing are water, liquid chemicals in a bucket, hose, pressurized can or cannon; dry powder in a can, box or pressurized can. Of these only water can be projected at the fire from a significant distance and only water is available affordably in large enough amounts to provide a reasonable affect of fire extinguishment from a distance due to volume for overwhelming the fire.

### BRIEF DESCRIPTION OF DRAWINGS

FIG. 1 illustrates a schematic diagram of the most two likely shapes and designs of a fire extinguishing projectile, however they could come in many forms and sizes.

FIG. 2 illustrates a schematic diagram of a portable, one man operated, projectile delivery machine

FIG. 3 illustrates a schematic diagram of a larger transportable delivery machine similar to a fire engine truck

FIG. 4 illustrates a schematic diagram of a detail of the delivery system built onto the larger transportable delivery machine

FIG. 5 illustrates a schematic diagram of a detail of one example of a delivery system for delivering the fire extinguishing projectiles to the point of the fire from a distance high above the ground showing an example of a standard fire truck equipped with a projectile firing machine/pump, an extension ladder which is outfitted with a supply hose in the extension ladder, an aiming nozzle through a window, firing the fire extinguishing projectiles at the fire inside the building, just under the roof. As the fire extinguishing projectiles impact with any object they shatter disbursing their fire extinguishing contents into an ever expanding fire extinguishing cloud that fills the room and covers all surfaces, cancelling the power of the fire to burn and spread.

FIG. 6 illustrates a schematic diagram of a close-up detail of the fire-proof metal extendable firing nozzle designed to control the flow and direction and finally the placement of the fire extinguishing projectiles; and all its features, having a supply hose, extendable nozzle body with multiple stages that slide outward toward the fire and can be retracted, an adjustable nozzle tip whose direction can be manipulated by the nozzle tip directional control cables, one on each side, top and bottom of the extendable nozzle. These cables are attached to cable anchors 607 on the nozzle tip and cable anchors and control lever (one for each cable) on the main body of the extendable nozzle. An optional adjustable, heat-resistant infrared camera may be attached to the fire proof metal extendable firing nozzle to enable user to view and find the fire points through the smoke and better direct the fire extinguishing projectiles at the most strategically advantageous points.

FIG. 6a illustrates a schematic diagram of a close-up detail of the adjustable nozzle tip and all its features, showing the final stage of the extendable nozzle 608 and having a tip that pivots on the hollow pivot ball through which the fire extinguishing projectiles travel, a plurality of directional control cables 601 to control the direction of the point left, right up or down, a plurality of cable casings, a plurality of cable anchors and a plurality of ball guides that guide the fire extinguishing projectiles into the hollow pivot ball.

FIG. 7 illustrates a system for extinguishing fires automatically that is triggered by the presence of high heat. This heat must be high enough to trigger this system only after people will have vacated the location so that it does not injure them. This system is as follows:
1. A layer of containers of carbon dioxide or other inflammable gas or liquid, whether incorporated into the drywall itself or held together in some material such that is can be installed onto a ceiling or wall like a blanket before the drywall is installed over it. These containers are designed to explode in the presence of high heat, causing substantial force to be projected toward the drywall and thus pulverizing it and sending it as a fine cloud or mist away from the ceiling or walls and toward the fire(s).
2. A form of drywall composed of part dry fire-extinguishing powder and part solidifying agent to force the powder to keep its form when formed during manufacture into a sheet of drywall

### DETAILED DESCRIPTION OF DRAWINGS

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout. Unless otherwise noted in this specification or in the claims, all of the terms used in the specification and the claims will have the meanings normally ascribed to these terms by workers in the art.

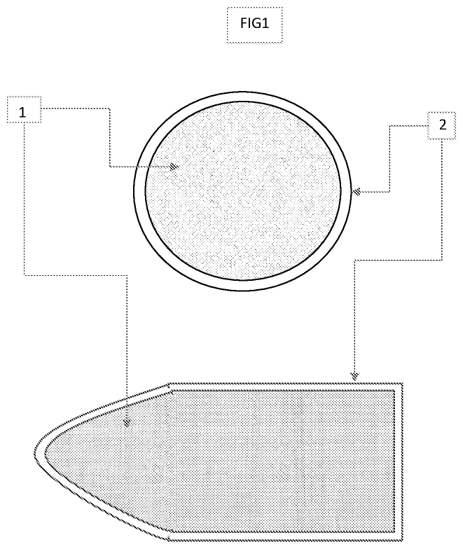

FIG. 1 illustrates a schematic diagram of a fire extinguishing projectile, designed aerodynamically to fly quickly and straight through the air, whose contents are mostly likely a dry power but could also be any form of water or non-water material. This figure illustrates two of many potential shapes possible for this invention. Item 100 denotes the contents of the projectile in both illustrated designs. Item 101 denotes the shell (round design) which is biodegradable, flame retardant plastic or other material or powder glass strong enough to stand the action of machine shooting out at high speeds but able to shatter easily upon impact on walls/ceilings item 3 denotes the shell (bullet design) which is biodegradable, flame retardant plastic or other material or powder glass strong enough to stand the action of machine shooting out at high speeds but able to shatter easily upon impact on walls/ceilings

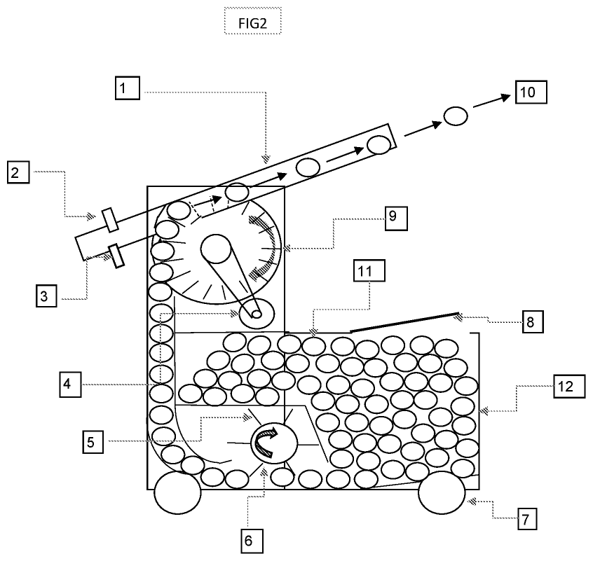

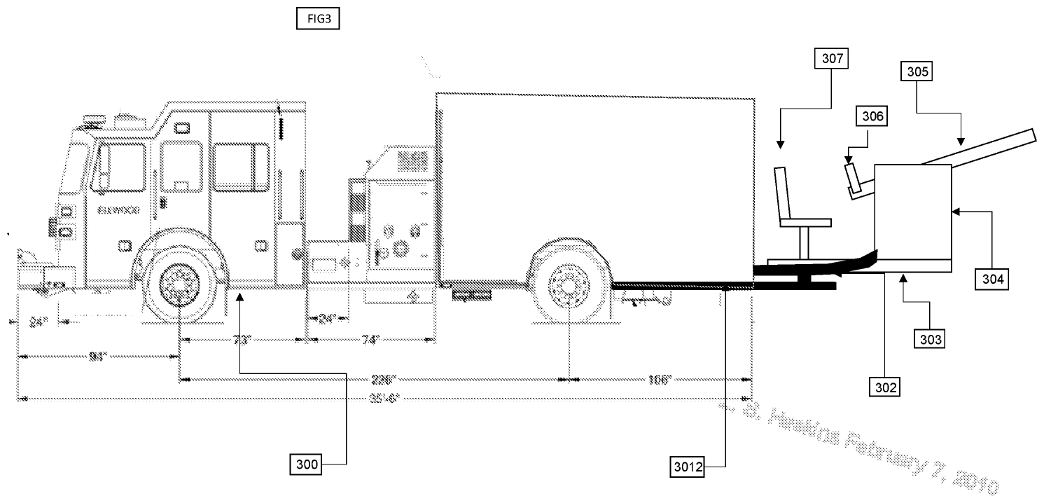

FIG. 2 illustrates a schematic diagram of a portable, one man operated, projectile delivery machine. Each number item in the illustration denotes as shown below:

### Item (Denotes)

200. The Firing barrel
201. Aiming sight
202. Firing trigger
203. Driving Motor
204. Wheel arms move fire extinguishing projectiles forward
205. Slow-moving ball mover wheel
206. Transportation wheel
207. Refill door
208, Fast-moving double wheel (one on each side of fire extinguishing projectiles) with soft rubber on inside of each wheel to grab the fire extinguishing projectiles and move them forward without breaking them, Alternative design: one wheel with flexible, semi-rigid arms that move fire extinguishing projectiles along in shaft
209. Direction of firing of projectile
210. Projectiles, stored in reservoir
211. Reservoir tank

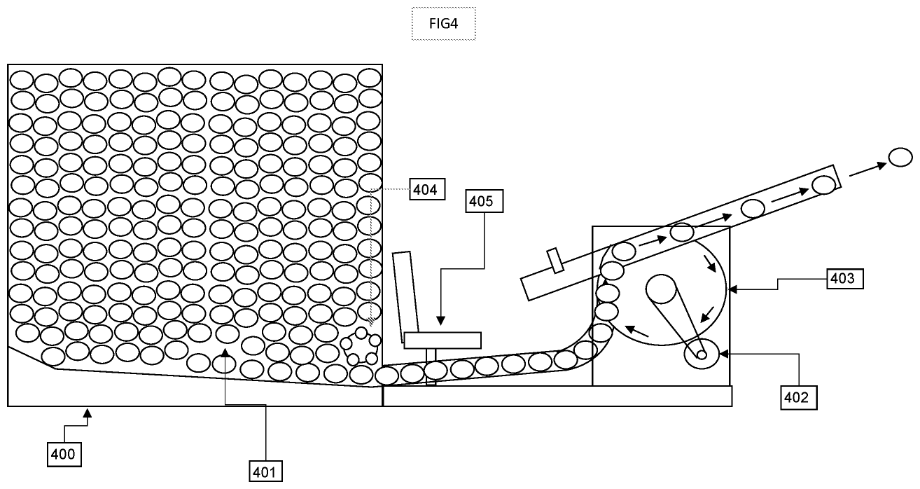

FIG. 3 illustrates a schematic diagram of a larger transportable delivery machine similar to a fire engine truck, Each number item in the illustration denotes as 10 shown below:

### Item (Denotes)

300. The delivery vehicle such as a fire truck
301. Tank containing extinguishing projectiles
302. Supply Hose
303. Pivoting Platform
304. firing Machine/cannon
305. Cannon barrel
306. Control Handles
307, Operator Seat

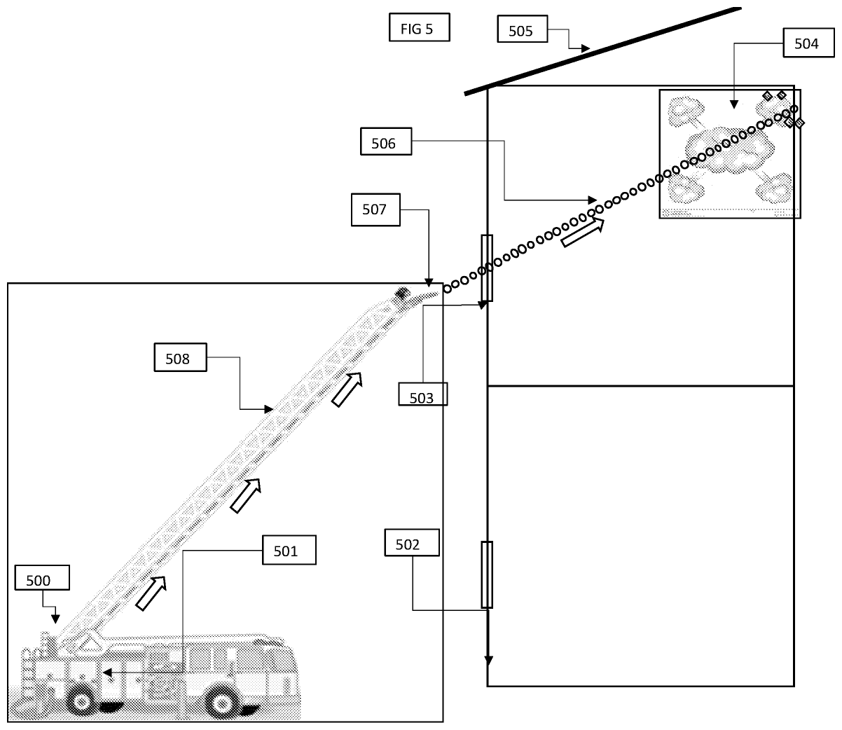

FIG. 4 illustrates a schematic diagram of a detail of the delivery system built onto the larger transportable delivery machine, Each number item in the illustration denotes as shown below:

### Item (Denotes)

400. Reservoir tank
401. Projectiles stored in reservoir tank
402. Projectile-shooting Motor
403. projectile-driving wheel with soft rubber flaps on inside of each wheel to grab the projectiles and move them forward without breaking them.
404. Slowly rotating motorized wheel with ball shapes on outer surface keeps fire extinguishing projectiles moving in direction of exit hole to supply hose
405. Operator seat

FIG. 5 illustrates a schematic diagram of a detail of one example of a delivery system for delivering the fire extinguishing projectiles 506 to the point of the fire from a distance high above the ground showing an example of a standard fire truck 500 equipped with a projectile firing machine/pump 501, an extension ladder 508 which is outfitted with a supply hose in the extension ladder, an aiming nozzle through a window 503, firing the fire extinguishing projectiles 506 at the fire inside the building 502, just under the roof 505. As the fire extinguishing projectiles 506 impact with any object they shatter disbursing their fire extinguishing contents into an ever expanding fire extinguishing cloud 504 that fills the room and covers all surfaces, cancelling the power of the fire to burn and spread, Each number item in the illustration denotes as shown below:

### Item (Denotes)

500. fire truck
501. projectile firing machine/pump
502. building
503. window
504. fire extinguishing cloud
505. roof
506. fire extinguishing projectiles
507. fire-proof metal extendable firing nozzle
508. Fire truck extendable ladder

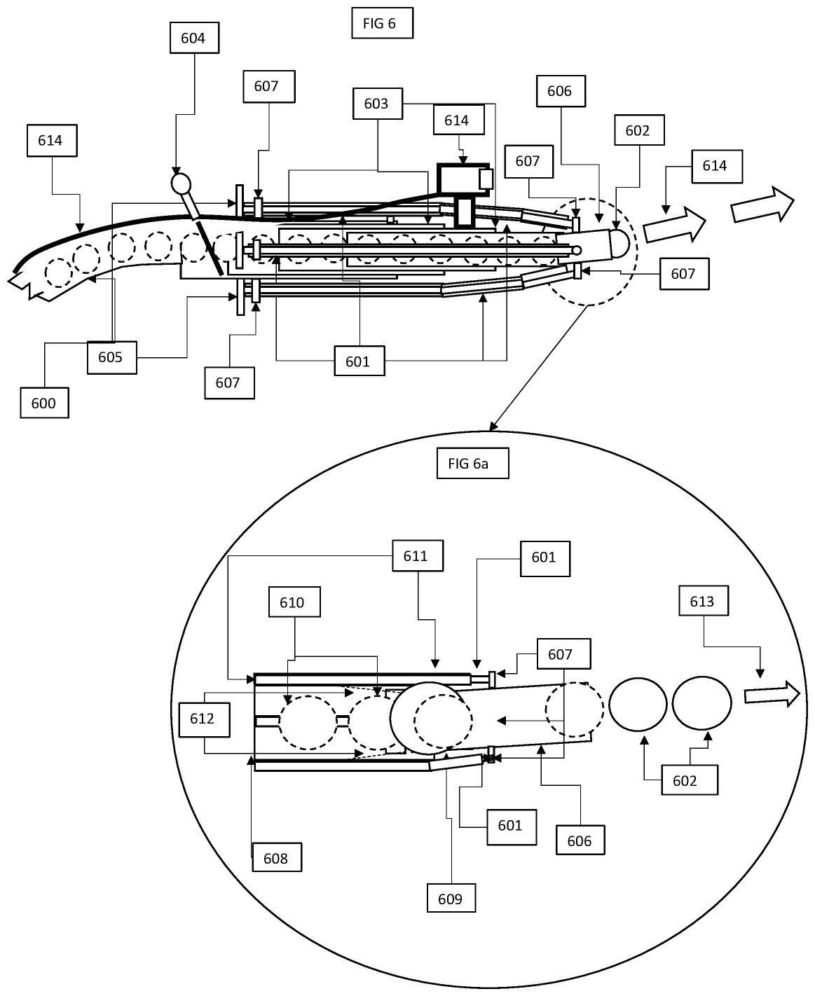

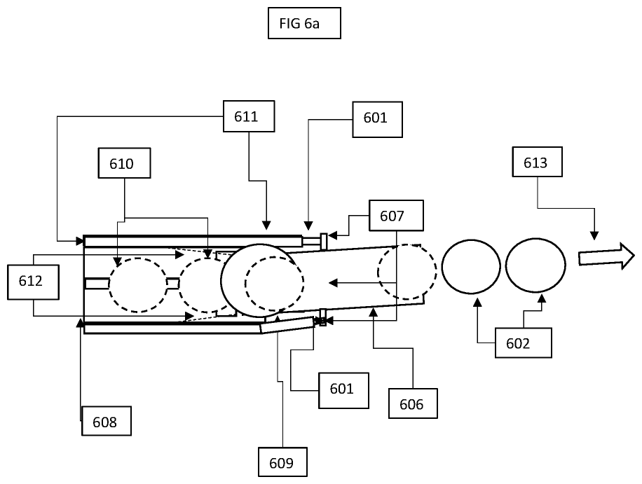

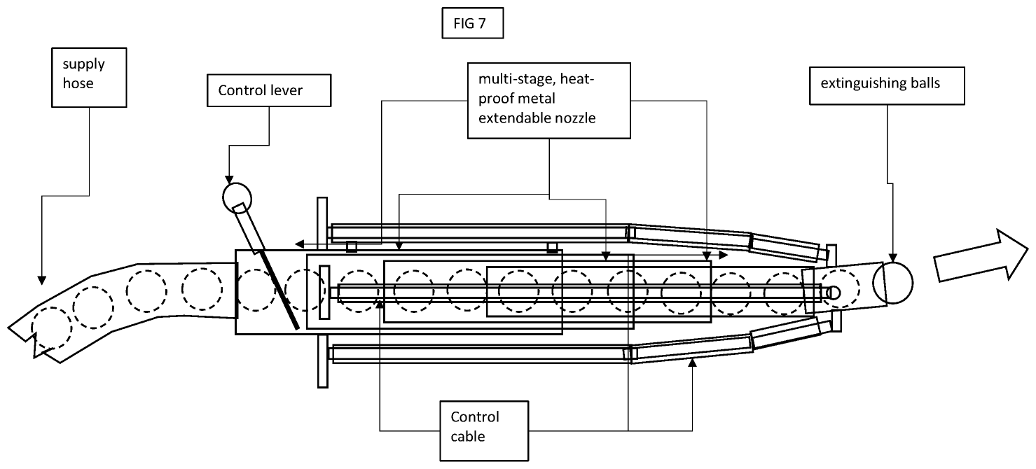

FIG. 6 illustrates a schematic diagram of a close-up detail of the fire-proof metal extendable firing nozzle designed to control the flow and direction 614 and finally the placement of the fire extinguishing projectiles 602; and all its features, having a supply hose 600, extendable nozzle body 603 with multiple stages that slide outward toward the fire and can be retracted, an adjustable nozzle tip 606 whose 30 direction can be manipulated by the nozzle tip 606 directional control cables 601, one on each side, top and bottom of the extendable nozzle. These cables are attached to cable anchors 607 on the nozzle tip and cable anchors 607 and control lever 605 (one for each cable) on the main body of the extendable nozzle, An optional adjustable, heat-resistant infrared camera 614 may be attached to the fire proof metal extendable firing nozzle to enable user to view and find the fire points through the smoke and better direct the fire extinguishing projectiles at the most strategically advantageous points. Each number item in the illustration denotes as shown below:

### Item (Denotes)

509. Supply hose
510. directional control cables
511. fire extinguishing projectiles
512. extendable nozzle body
513. flow and direction
514. control lever
515. adjustable nozzle tip
516. cable anchors
614. heat-resistant infrared camera and lens

FIG. 6a illustrates a schematic diagram of a close-up detail of the adjustable nozzle tip and all its features, showing the final stage of the extendable nozzle 608 and having a tip 606 that pivots on the hollow pivot ball 609 through which the fire extinguishing projectiles 610 travel, a plurality of directional control cables 601 to control the direction of the point left, right up or down, a plurality of cable casings 611, a plurality of cable anchors 612 and a plurality of ball guides 613 that guide the fire extinguishing projectiles 610 into the hollow pivot ball 609. Each number item in the illustration denotes as shown below:

### Item (Denotes)

600. Supply hose
601. directional control cables
602. fire extinguishing projectiles
603. extendable nozzle body
604. flow and direction
605. control lever
606. adjustable nozzle tip
607. cable anchors
608. final stage of the extendable nozzle
609. hollow pivot ball
610. fire extinguishing projectiles
611. cable casings
612. cable anchors
613. ball guides

FIG. 7 illustrates a system for extinguishing fires automatically that is triggered by the presence of high heat. This heat must be high enough to trigger this system only after people will have vacated the location so that it does not injure them. This system is as follows:
1. A layer of containers 614 of carbon dioxide or other inflammable gas or liquid under pressure, whether incorporated into the drywall 615 and/or 616 itself or held together in some material such that is can be installed onto a ceiling or wall like a blanket before the drywall 615 and/or 616 is installed over it. said containers 614 are designed to explode in the presence of high heat, causing substantial force 621 to be projected toward the drywall 615 and/or 616 and thus pulverizing it and sending it as a fine cloud or mist away from the ceiling or walls and toward the fire(s).
2. A form of drywall 615 and/or 616 composed of part dry fire-extinguishing powder and part solidifying agent to force the powder to keep its form when formed during manufacture into a sheet of drywall

When the heat from the fire penetrates the drywall 615 and/or 616 on the ceiling or walls and reaches a temperature set at manufacture it will cause the containers 614 of carbon dioxide or other inflammable gas or liquid under pressure to explode violently with enough force 621 to drive said specially designed fire-extinguishing drywall 615 and/or 616 away from the ceiling and/or walls) and toward the fire(s) such that is pulverizes the drywall 615 and/or 616 into a fine cloud or vapor that will coat many or all surfaces in the room and extinguish the fire(s).
614. non-flammable plastic or powder glass CO2 tubes that will burst under heat
615. Fire extinguishing powder w/non-flammable bonding additive/fortifier
616. Drywall mix w/fire extinguishing powder
617. paintable face
618. Manilla Paper
619. Paper
620. Rigid heavy or metal-lined Paper directs explosive charge downward toward fire
621. direction of explosive charge

1. A system, whether manually mobile (carry) or powered mobile such as but not limited to on a cart or truck, helicopter, airplane or boat, of delivering fire extinguishing agents in a plurality of projectiles filled with fire extinguishing agent(s) such as, but not limited to water, dry or liquid chemical(s), which projectiles can be thrown or fired from a machine or from a machine through a hose with or without a control nozzle, with or without an infrared camera to facilitate viewing of fire site through smoke and water mist, at adjustably low or high speeds and with adjustably low or high rapidity and utilizing spring rotating drive wheels to move projectiles at high speeds our of firing chamber and having a rifling shape and design to the inner walls of the firing nozzle chamber; and,

2. A projectile of a plurality of shapes and sizes designed to be fired from a delivery system with high or low rapidity and high or low velocity, depending on user settings chosen in firing/projectile machine, such that it survives the firing process and the flying through the air to the point of the fire but designed also to easily shatter upon impact with solid objects inside or outside the burning object (such as a building or automobile) into a fine cloud or mist that will cover all or many surfaces, extinguishing the fire(s) and having a rifling shape and design to the sides of said projectile to facilitate rapid spin in flight so as to provide more accurate targeting; and,

3. A fire-extinguishing system inside building containing:
specially designed form of drywall or plaster made of part dry fire extinguishing agent mixed with part stabilizing, solidifier agent; and,
an assembly of containers of carbon dioxide or other inert gas under pressure installed flat on ceiling or walls before said drywall, designed to burst under high heat conditions that will pulverize said fire-extinguishing drywall away from ceiling or walls, such that it covers the fire(s) and extinguishes them.
